(19) United States
(12) Patent Application Publication
(10) Pub. No.: US 2010/0133916 A1
(43) Pub. Date: Jun. 3, 2010

(54) POWER TRANSFER APPARATUS AND METHOD FOR TRANSFERRING ELECTRIC POWER

(75) Inventor: Masaki SATO, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA

(21) Appl. No.: 12/547,547

(22) Filed: Aug. 26, 2009

(30) Foreign Application Priority Data
Nov. 28, 2008 (JP) 2008-305041

(51) Int. Cl. H01F 38/14; H02J 7/00

(52) U.S. Cl. 307/104; 320/108

(57) ABSTRACT

A power transfer apparatus including a first device and a second device having a first coil and a second coil, respectively, is provided. The first device is configured to produce primary power through the primary coil upon being supplied with external power and to be controlled by a provided control signal so that the primary power decreases and increases upon the control signal representing a first value and a second value, respectively. The second device is configured to be joined with the first device so that the secondary coil is electromagnetically coupled with the primary coil. The second device is configured to produce secondary power upon the secondary coil being driven through the electromagnetic coupling. The second device is configured to provide the first device with the control signal representing the first value and the second value upon the secondary power being greater and smaller than a reference value, respectively.

### CROSS REFERENCE TO RELATED APPLICATIONS

This application is based upon and claims the benefit of priority from the prior Japanese Patent Application No. 2008-305041 filed on Nov. 28, 2008; the entire contents of which are incorporated herein by reference.

### BACKGROUND OF THE INVENTION

1. Field of the Invention

The present invention relates to a power transfer apparatus and a method for transferring electric power, and in particular to a power transfer apparatus adapted for contactless power transfer not through an electrical contact. The power transfer apparatus is configured to feed a secondary output voltage back to a primary side so as to make the secondary output voltage stable.

2. Description of the Related Art

An apparatus configured to transfer electric power by means of electromagnetic induction of a transformer is known, as disclosed in Japanese examined patent application publication (Toroku), No. B-3416863. According to paragraphs 0167-0168 and FIG. 22 of JP-B-341 6863, the apparatus transfers electric power from a primary side to a secondary side through a transformer, and transfers a signal from the secondary side to the primary side through the transformer. transformer. As to the signal transfer, the apparatus converts a secondary output voltage into a frequency signal as a load condition signal by using a V-f conversion and so on, and transfers the frequency signal to the primary side. The apparatus thereby controls an oscillating circuit of the primary side for a feedback control so as to make the secondary output voltage stable. The apparatus can be applied to a use for which the primary side of the transformer can be easily put on and taken off the secondary side in a case where, e.g., the primary and secondary sides are a battery charger and a mobile phone, respectively. The apparatus transfers the electric power and the signal while the mobile phone is being put on the battery charger.

Another apparatus configured to similarly transfer electric power by means of electromagnetic induction of a transformer is known, as disclosed in Japanese patent publication of unexamined applications (Kokai), No. A-2003-348775. According to FIGS. 1-2 and paragraphs 0031-0033 of JP-A-2003-348775, the apparatus transfers electric power from a primary side to a secondary side through an output transformer 103, and transfers a signal from the secondary side to the primary side through an optical communication circuit 108. As to the signal transfer, the apparatus converts a secondary output voltage into a digital signal and transfers the digital signal to the primary side through the optical communication circuit 108. The apparatus thereby controls the primary side for a feedback control so as to make the secondary output voltage stable. The apparatus can be applied not to a use for which the primary side of the transformer can be easily put on and taken off the secondary side but to a use for which the primary side is always put on the secondary side in a case where, e.g., the primary and secondary sides are a main body of a vehicle and a steering wheel. The apparatus transfers the electric power and the signal while the steering wheel is always put on the main body of the vehicle. Thus, the output transformer 103 need not have an internal configuration that can be divided, put on and taken off. The optical communication circuit 108 need not have an internal configuration that can be divided, put on and taken off, either.

According to JP-B-3416863, as the secondary output voltage is converted into a frequency signal by using a V-f conversion and so on, the signal transfer through the transformer requires a broad frequency bandwidth corresponding to an output voltage variation. The signal transfer of JP-B-3416863 is required to be stable in the required frequency bandwidth.

According to JP-A-2003-348775, as digital data corresponding to the secondary output voltage is serially exchanged, the signal transfer through the optical communication requires significant time upon the data size being large. The signal transfer of JP-A-2003-348775 may thereby cause a time lag, and is possibly unable to react to a steep change of the secondary output voltage.

### SUMMARY OF THE INVENTION

Accordingly, an advantage of the present invention is to provide a power transfer apparatus configured to transfer a signal for feeding a secondary output voltage transferred through contactless power transfer back to the primary side without a need of a broad frequency bandwidth. The power transfer apparatus is configured to reduce a time lag by reducing digital data to be transferred. The power transfer apparatus is configured to immediately react to a steep change of the secondary output voltage.

To achieve the above advantage, one aspect of the present invention is that a power transfer apparatus including a first device and a second device having a first coil and a second coil, respectively, is provided. The first device is configured to produce primary power through the primary coil upon being supplied with external power and to be controlled by a provided control signal so that the primary power decreases and increases upon the control signal representing a first value and a second value, respectively. The second device is configured to be joined with the first device so that the secondary coil is electromagnetically coupled with the primary coil. The second device is configured to produce secondary power upon the secondary coil being driven through the electromagnetic coupling. The second device is configured to provide the first device with the control signal representing the first value and the second value upon the secondary power being greater and smaller than a reference value, respectively.

### BRIEF DESCRIPTION OF THE DRAWINGS

FIG. 1 is a block diagram of a power transfer apparatus 100 of a first embodiment of the present invention.

FIG. 2 is a block diagram of a power transfer apparatus 100 of a second embodiment of the present invention.

FIG. 3 shows a structure of an optical communication portion of the power transfer apparatus 100 of the second embodiment of the present invention.

### DETAILED DESCRIPTION OF THE INVENTION

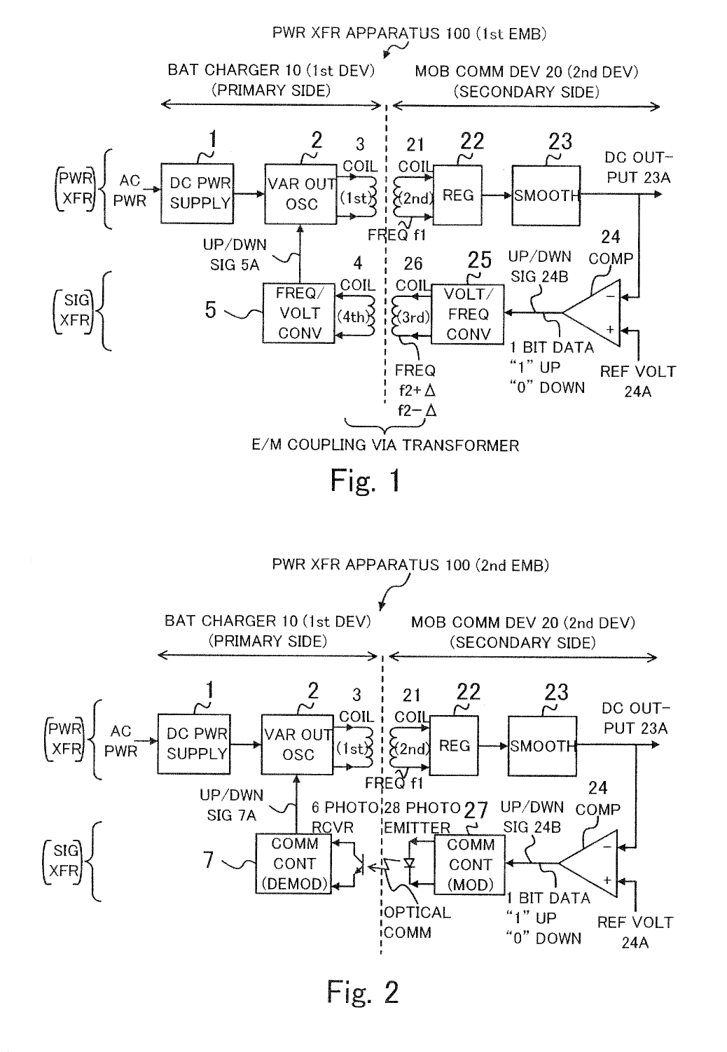

FIG. 1 is a block diagram of a power transfer apparatus 100 of a first embodiment of the present invention. The power transfer apparatus 100 includes a battery charger 10 (first device on the primary side) and a mobile communication device 20 (second device on the secondary side). The mobile communication device 20 can be easily put on and taken off the battery charger 10. The power transfer apparatus 100 transfers electric power and a signal while the mobile communication device 20 is being put on the battery charger 10.

An upper half of FIG. 1 shows a portion of the power transfer apparatus 100 for transferring electric power from the battery charger 10 to the mobile communication device 20. A lower half of FIG. 1 shows a portion of the power transfer apparatus 100 for transferring a signal from the mobile communication device 20 to the battery charger 10 so as to control feedback for making an output of the power transferred to the mobile communication device 20 stable.

The configuration of the power transfer apparatus 100 will be described in detail below. The battery charger 10 is constituted by a dc power supply 1, a variable output oscillator 2, a transformer coil 3 (first coil), a transformer coil 4 (fourth coil), a frequency/voltage converter 5 and so on. The mobile communication device 20 is constituted by a transformer coil 21 (second coil), a regulating circuit 22, a smoothing circuit 23, a comparator 24, a voltage/frequency converter 25, a transformer coil 6 (third coil) and so on.

The battery charger 10 is connected to an external ac power source and produces dc power by means of the dc power supply 1. The variable output oscillator 2 is supplied by the dc power supply 1 with the dc power, oscillates at a frequency f1 and drives the transformer coil 3 (first coil on the primary side) with an output of the oscillation. The battery charger 10 transfers electric power to the transformer coil 21 (second coil on the secondary side) of the mobile communication device 20.

An output of the transformer coil 21 (second coil on the secondary side) of the mobile communication device 20 is regulated by the regulating circuit 22, and then smoothed by the smoothing circuit 23 so that a dc output 23A is obtained. The dc output 23A is provided to a charge control circuit (not shown) included in the mobile communication device 20 so as to charge a battery (not shown).

The comparator 24 compares the dc output 23A with a reference voltage 24A so as to produce a waveform-shaped binary up/down signal 24B.

The up/down signal 24B represents one bit digital data having a value of “0” corresponding to “down” and a value of “1” corresponding to “up” upon the dc output 23A being greater and smaller than the reference voltage 24A, respectively.

The voltage/frequency converter 25 is provided with the binary signal of the up/down signal 24B as an input, performs a voltage-to-frequency conversion process and drives the transformer coil 6 (third coil) by using a frequency-converted output. The output of the voltage/frequency converter 25 has a frequency of f2+? and f2−? upon the up/down signal 24B having a value of “1” and a value of “0”, respectively. The frequency f2 is different from the frequency f1 for power transfer. The frequencies f2+? and f2−? are almost same as f2 as the value ? is very small.

Upon being driven, the transformer coil 26 (third coil) transfers a signal to the transformer coil 4 (fourth coil) through electromagnetic induction at the frequencies f2+? and f2−?. The above frequency range is just around the frequency f2, and it is enough to cause electromagnetic induction only around the frequency f2.

An output of the transformer coil 4 (fourth coil) is provided to the frequency/voltage converter 5 so that an up/down signal 5A of a voltage level corresponding to the input frequency value is obtained. As the frequency has two values, f2+? and f2−?, the output of the frequency/voltage converter 5 is binary.

The up/down signal 5A similarly has a value of “0” and a value of “1” upon the up/down signal 24B having a value of “0” corresponding to “down” and a value of “1” corresponding to “up”, respectively.

The variable output oscillator 2 controls a decrease and an increase in an output of the variable output oscillator 2 by using the up/down signal 5A. That is, the power transfer apparatus 100 performs a feedback control such that the output of the variable output oscillator 2 decreases and increases upon the dc output 23A being greater and smaller than the reference voltage 24A, respectively. The dc output 23A is thereby made stable around the reference voltage 24A.

The comparator 2 is, but not limited to, an ordinary comparator as described above, and may be a comparator having a hysteresis characteristic such as a Schmitt comparator. In such a case, the feedback control works such that the repetition of the decrease and increase of the output of the variable output oscillator 2 slows down.

Although the mobile communication device 20 (second device) can be easily put on and taken off the battery charger 10 (first device) as described above, the present invention can be applied to another power transfer apparatus constituted by a first device and a second device integrated with and fixed to each other.

According to the first embodiment of the present invention, as the signal transfer through the electromagnetic induction is performed on the binary basis, the power transfer apparatus only needs the two frequencies, f2+? and f2−?, for the electromagnetic induction. As the frequency remains in a narrow range around the frequency f2, it is enough to make sure of the electromagnetic induction around the frequency f2. The power transfer apparatus can thereby enhance reliability of the signal transfer.

FIG. 2 is a block diagram of a power transfer apparatus 100 of a second embodiment of the present invention. Each of portions which is a same as the corresponding one of the first embodiment (shown in FIG. 1) is given a same reference numeral, and remaining portions different from the portions of the first embodiment will be mainly explained. An upper half of FIG. 2 shows a same portion of the power transfer apparatus 100 as shown in the upper half of FIG. 1 for transferring electric power from the battery charger 10 to the mobile communication device 20, and its explanation is omitted. A lower half of FIG. 2 shows a portion configured to transfer a signal for output stability, similarly as the corresponding portion of the first embodiment, but by using optical communication for the signal transfer.

The configuration of the power transfer apparatus 100 will be described in detail below. The battery charger 10 is constituted by the dc power supply 1, the variable output oscillator 2, the transformer coil 3 (first coil), a photo receiver 6 for optical communication, a communication controller 7 that is a demodulator and so on. The mobile communication device 20 is constituted by the transformer coil 21 (second coil), the regulating circuit 22, the smoothing circuit 23, the comparator 24, a communication controller 27 that is a modulator, a photo emitter 28 for the optical communication and so on.

The portion of the power transfer apparatus 100 for power transfer is a same as the corresponding portion of the first embodiment (shown in FIG. 1), and its explanation is omitted. The portion of the power transfer apparatus 100 for the signal transfer will be explained below. The communication controller 27 is provided with the up/down signal 24B (binary) as an input, performs a modulation process for the optical communication, drives the photo emitter 28 and sends an optical signal to the photo receiver 6 of the battery charger 10, i.e., the optical communication.

The photo receiver 6 of the battery charger 10 provides the communication controller 7 with an optical-electric conversion output. The communication controller 7 demodulates the optical-electric conversion output so as to produce an up/down signal 7A of a voltage level. As the up/down signal 24B is binary, the up/down signal 7A, which is demodulated from the signal binary-modulated by using the binary up/down signal 24B, is also binary.

The up/down signal 7A similarly has a value of “0” and a value of “1” upon the up/down signal 24B having a value of “0” corresponding to “down” and a value of “1” corresponding to “up”, respectively.

The variable output oscillator 2 controls a decrease and an increase in an output of the variable output oscillator 2 by using the up/down signal 7A. That is, the power transfer apparatus 100 performs a feedback control such that the output of the variable output oscillator 2 decreases and increases upon the dc output 23A being greater and smaller than the reference voltage 24A, respectively. The dc output 23A is thereby made stable around the reference voltage 24A.

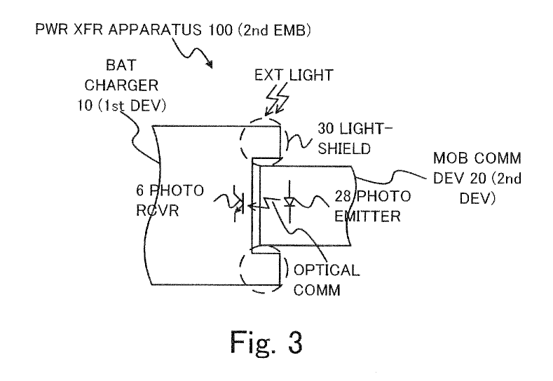

FIG. 3 shows a structure of an optical communication portion of the power transfer apparatus 100 of the second embodiment of the present invention. A lightshield 30 is provided so that the optical communication between the photo emitter 28 and the photo receiver 6 is not affected by external light upon the mobile communication device 20 being put on the battery charger 10. The power transfer apparatus 100 can thereby perform stable optical communication without being affected by external light.

The photo emitter 28 and the photo receiver 6 are configured to be separate and the one of them can be easily put on and taken off the other of them so that the mobile communication device (second device) can be put on and taken off the battery charger 110 (first device). For another power transfer apparatus constituted by a first device and a second device integrated with and fixed to each other, though the photo emitter 28 and the photo receiver 6 may form a photo coupler and so on by being Integrated with each other. The photo coupler is not affected by external light, and thus needs no lightshield.

The power transfer apparatus 100 is provided with, but not limited to, the optical communication subsystem for the signal transfers and may be provided with another communication subsystem as long as the transmitter and receiver sides are electrically isolated from each other.

According to the second embodiment of the present invention, the optical signal transfer needs only one bit data of the up/down signal 24B, and thus can save time required for the signal transfer. The power transfer apparatus 100 can thereby reduce a time lag of the feedback control and can thereby react to an abrupt change of the output voltage on the secondary side.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A power transfer apparatus, comprising:
a first device having a primary coil, the first device being configured to produce primary power through the primary coil upon being supplied with external power and to be controlled by a provided control signal so that the primary power decreases and increases upon the control signal representing a first value and a second value, respectively; and
a second device having a secondary coil, the second device being configured to be joined with the first device so that the secondary coil is electromagnetically coupled with the primary coil, the second device being configured to produce secondary power upon the secondary coil being driven through the electromagnetic coupling, the second device being configured to provide the first device with the control signal representing the first value and the second value upon the secondary power being greater and smaller than a reference value, respectively.

2. The power transfer apparatus according to claim 1, wherein the second device is configured to provide the first device with the control signal through a circuit configured to connect the first device and the second device on an electrically isolated basis.

3. The power transfer apparatus according to claim 1, wherein
the first device and the second device are constituted by including a first coil and a second coil, respectively, being arranged to be electromagnetically coupled with each other upon the first device and the second device being joined with each other, and
the second device is configured to provide the first device with the control signal through the electromagnetic coupling between the first coil and the second coil.

4. The power transfer apparatus according to claim 1, wherein
the first device and the second device are constituted by including a first coil and a second coil, respectively, being arranged to be electromagnetically coupled with each other upon the first device and the second device being joined with each other, and
the second device is configured to provide the first device with the control signal of a first frequency and a second frequency corresponding to the first value and the second value, respectively, through the electromagnetic coupling between the first coil and the second coil.

5. The power transfer apparatus according to claim 1, wherein
the first device and the second device are constituted by including a first coil and a second coil, respectively, being arranged to be electromagnetically coupled with each other upon the first device and the second device being joined with each other,
the first device is constituted by further including a dc power supply configured to produce dc power upon being supplied with the external power, a variable output oscillator configured to produce the primary power upon being provided with the dc power, and a frequency/voltage converter configured to convert the control signal of a first frequency and a second frequency provided by the first coil and corresponding to the first value and the second value, respectively, into a signal representing the first value and the second value by means of a voltage to be applied to the variable output oscillator so that the primary power decreases and increases, respectively, and
the second device is constituted by further including a regulating circuit configured to regulate power transferred from the primary coil to the secondary coil, a smoothing circuit configured to smooth the regulated power so as to produce the secondary power, a comparator configured to compare the secondary power with the reference value, and a voltage/frequency converter configured to convert an output voltage of the comparator into the control signal to be provided to the second coil.

6. The power transfer apparatus according to claim 1, wherein
the first device and the second device are constituted by including a photo receiver and a photo emitter, respectively, being arranged to be optically coupled with each other such that the photo receiver can receive light emitted from the photo emitter upon the first device and the second device being joined with each other, and
the second device is configured to provide the first device with the control signal carried by the emitted light.

7. The power transfer apparatus according to claim 1, wherein
the first device and the second device are constituted by including a photo receiver and a photo emitter, respectively, being arranged to be optically coupled with each other such that the photo receiver can receive light modulated and emitted by the photo emitter upon the first device and the second device being joined with each other, and
the second device is configured to provide the first device with the control signal carried by a first modulated light and a second modulated light corresponding to the first value and the second value, respectively.

8. The power transfer apparatus according to claim 1, wherein
the first device and the second device are constituted by including a photo receiver and a photo emitter, respectively, being arranged to be optically coupled with each other such that the photo receiver can receive light modulated and emitted by the photo emitter upon the first device and the second device being joined with each other,
the first device is constituted by further including a dc power supply configured to produce dc power upon being supplied with the external power, a variable output oscillator configured to produce the primary power upon being provided with the dc power, and a first communication controller configured to demodulate the control signal carried by a first modulated light and a second modulated light provided by the photo receiver and corresponding to the first value and the second value, respectively, into a signal representing the first value and the second value by means of a voltage to be applied to the variable output oscillator so that the primary power decreases and increases, respectively, and
the second device is constituted by further including a regulating circuit configured to regulate power transferred from the primary coil to the secondary coil, a smoothing circuit configured to smooth the regulated power so as to produce the secondary power, a comparator configured to compare the secondary power with the reference value, and a second communication controller configured to modulate light to be emitted from the photo emitter for carrying the control signal.

9. The power transfer apparatus according to claim 1, wherein the first device and the second device are integrated with each other

10. The power transfer apparatus according to claim 6, wherein the first device and the second device are integrated with each other, and the photo emitter and the photo receiver are integrated with each other so as to constitute a photocoupler.

11. The power transfer apparatus according to claim 6, wherein the second device can be put on and taken off the first device.

12. The power transfer apparatus according to claim 6, wherein the second device can be put on and taken off the first device, and the optical coupling is protected from external light by a lightshield.

13. A method for transferring electric power from a first device to a second device, the first device and the second device including a primary coil and the secondary coil, respectively, comprising:
joining the first device and the second device with each other so that the primary coil and the secondary coil are electromagnetically coupled with each other;
producing primary power through the primary coil by supplying the first device with external power;
producing secondary power by driving the secondary coil through the electromagnetic coupling;
providing the first device with a control signal representing a first value and a second value upon the secondary power being greater and smaller than a reference value, respectively; and
controlling the primary power by means of the control signal so that the primary power decreases and increases upon the control signal representing the first value and the second value, respectively.

14. The method for transferring electric power according to claim 13, wherein the first device is provided with the control signal through a circuit configured to connect the first device and the second device on an electrically isolated basis.

15. The method for transferring electric power according to claim 13, wherein
the first device and the second device are constituted by including a first coil and a second coil, respectively, being arranged to be electromagnetically coupled with each other upon the first device and the second device being joined with each other, and
the second device is configured to provide the first device with the control signal through the electromagnetic coupling between the first coil and the second coil.

16. The method for transferring electric power according to claim 13, wherein
the first device and the second device are constituted by including a photo receiver and a photo emitter, respectively, being arranged to be optically coupled with each other such that the photo receiver can receive light emitted from the photo emitter upon the first device and the second device being joined with each other, and
the second device is configured to provide the first device with the control signal carried by the emitted light.
